(19) United States
(12) Patent Application Publication
(10) Pub. No.: US 2011/0216376 A1
(43) Pub. Date: Sep. 8, 2011

(54) System For And Method Of Providing Enhanced Copy Protection On A Reader Device

(75) Inventor: Serge Rutman, Boulder Creek, CA (US)

(73) Assignee: SKIFF, INC., New York, NY (US)

(21) Appl. No.: 12/718,110

(22) Filed: Mar. 5, 2010

(51) Int. Cl. H04N 1/40; G09G 3/30

(52) U.S. Cl. 358/448; 345/76

(57) ABSTRACT

A system for and method of providing enhanced copy protection on a reader device in accordance with exemplary embodiments may include detecting orientation data that indicates an orientation of a display screen of the reader device with reference to a horizontal surface, processing the orientation data to determine whether the orientation of the display screen of the reader device is such that the display screen is facing and aligned with the horizontal surface, and restricting display of electronic content on the display screen of the reader device based on a determination that the display screen is facing and aligned with the horizontal surface.

### FIELD OF THE INVENTION

The present invention relates to copy protection, generally, and a system for and method of providing enhanced copy protection on a reader device, in particular.

### BACKGROUND INFORMATION

In general, paper-based distribution of print media content (e.g., newspapers, magazines, books, printed documents) may become obsolete in the near future. Many print media companies may begin to distribute such print media content electronically in an attempt to remain competitive. Electronic distribution of print media content, however, may significantly increase opportunities for unauthorized users to access proprietary information. In certain cases, print media content that is electronically distributed to reader devices may be easily accessed by unauthorized users given the strength of current copy protection technology.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 illustrates a block diagram of an enhanced copy protection system according to an embodiment of the invention;

FIG. 2 illustrates exemplary modules of a reader device according to an embodiment of the invention;

FIG. 3 illustrates exemplary modules of a copy protection system according to an embodiment of the invention;

FIG. 4 illustrates a schematic diagram of a reader device in a copy detection configuration according to an embodiment of the invention;

FIG. 5 is a flow chart illustrating a method of providing enhanced copy protection on a reader device according to an embodiment of the invention; and

FIG. 6 is a flow chart illustrating another method of providing enhanced copy protection on a reader device according to an embodiment of the invention.

### SUMMARY OF EMBODIMENTS OF THE INVENTION

At least one exemplary embodiment may provide a method of providing enhanced copy protection on a reader device. This embodiment may include detecting orientation data that indicates an orientation of a display screen of the reader device with reference to a horizontal surface, processing the orientation data to determine whether the orientation of the display screen of the reader device is such that the display screen is facing and aligned with the horizontal surface, and restricting display of electronic content on the display screen of the reader device based on a determination that the display screen is facing and aligned with the horizontal surface.

Another exemplary embodiment according to this invention may provide a system for providing enhanced copy protection on a reader device. This embodiment may include a copy detection computing apparatus configured to detect orientation data that indicates an orientation of a display screen of the reader device with reference to a horizontal surface and process the orientation data to determine whether the orientation of the display screen of the reader device is such that the display screen is facing and aligned with the horizontal surface and a copy protection computing apparatus configured to restrict display of electronic content on the display screen of the reader device based on a determination that the display screen is facing and aligned with the horizontal surface.

### DETAILED DESCRIPTION OF EMBODIMENTS OF THE INVENTION

Currently, paper-based publications (e.g., hard copies of newspapers, hard copies of magazines) may be distributed to subscribers using traditional delivery mechanisms (e.g., home delivery via publication delivery vehicles, office delivery via publication delivery vehicles). Advancements in electronic distribution technologies may support the distribution of electronic versions of publications (e.g., perishable publication content, web-based content) to be delivered to end-user devices (e.g., reader devices). Such electronic distribution, however, may increase the risk that proprietary information is accessed by unauthorized users. Though some copy protection technologies decrease unauthorized access to proprietary information, these technologies may not provide sufficient protection against in-the-clear copying (e.g., making a copy of the proprietary information by scanning the display screen of a reader device while the proprietary information is being displayed).

Electronic content displayed on a reader device may be protected from in-the-clear copying using an enhanced copy protection system. An enhanced copy protection system may communicatively couple reader devices and a copy protection system. In one embodiment, electronic content displayed on a reader device may be protected from in-the-clear copying using copy detection mechanisms and copy protection mechanisms configured to operate on the reader device. In another embodiment, electronic content displayed on a reader device may be protected from in-the-clear copying using copy risk assessment mechanisms configured to operate on the copy protection system.

A copy detection mechanism may include techniques that detects that electronic content displayed on a display screen of a reader device is being copied using a scanning device (e.g., a copy machine, a scanner). In one embodiment, a copy detection mechanism may include using any, or a combination, of orientation sensors, gravity direction detection mechanisms, and compasses (e.g., solid state compasses) coupled to a reader device to detect whether the display screen of the reader device is facing a scanning device. In another embodiment, a copy detection mechanism may include using a configuration of photo detectors coupled to a reader device to detect whether a light (from a scanning device) has scanned the display screen of the reader device. In another embodiment, a copy detection mechanism may include using a combination of page turn detection techniques (e.g., techniques that determine the amount of pages of electronic content turned) and motion sensing devices (e.g., motion sensors, orientation sensors) to detect whether a pre-determined amount of pages have been turned without the position of the reader device being altered.

A copy protection mechanism may include techniques that protects electronic content displayed on a display screen of a reader device from unauthorized in-the-clear copying. In one embodiment, a copy protection mechanism may include displaying watermark data (e.g., displaying “Unauthorized Copying Detected”) with the electronic content. In another embodiment, a copy protection mechanism may include identifying the reader device on which the unauthorized in-the-clear copying has occurred, identifying a user name (e.g., a registered user of the reader device), identifying the approximate location of the unauthorized in-the-clear copying event, and identifying the data of the unauthorized in-the-clear copying event. Such information may be used to limit additional unauthorized in-the-clear copying. In another embodiment, a copy protection mechanism may include deleting at least a portion of the electronic content suspected of being copied. In another embodiment, a copy protection mechanism may include displaying warning data (e.g., displaying “Copying Activity Is Not Authorized”) with the electronic content. In another embodiment, a copy protection mechanism may include disabling a reader device or disabling the display of electronic content on a reader device.

A copy risk assessment mechanism may include techniques that assesses the risk of electronic content displayed on a display screen of a reader device being subject to unauthorized in-the-clear copying. In one embodiment, a copy risk assessment mechanism may include performing risk assessment processing techniques on copy detection event log data (e.g., event time data, event page rate data, event content data, event location data, reader device identification data, user identification data) received from a reader device to determine the likelihood that electronic content displayed on the reader device is subject to unauthorized in-the-clear copying. A risk assessment processing technique may include applying a business rule to the copy detection event log data to determine whether the electronic content displayed on the reader device is subject to unauthorized in-the-clear copying.

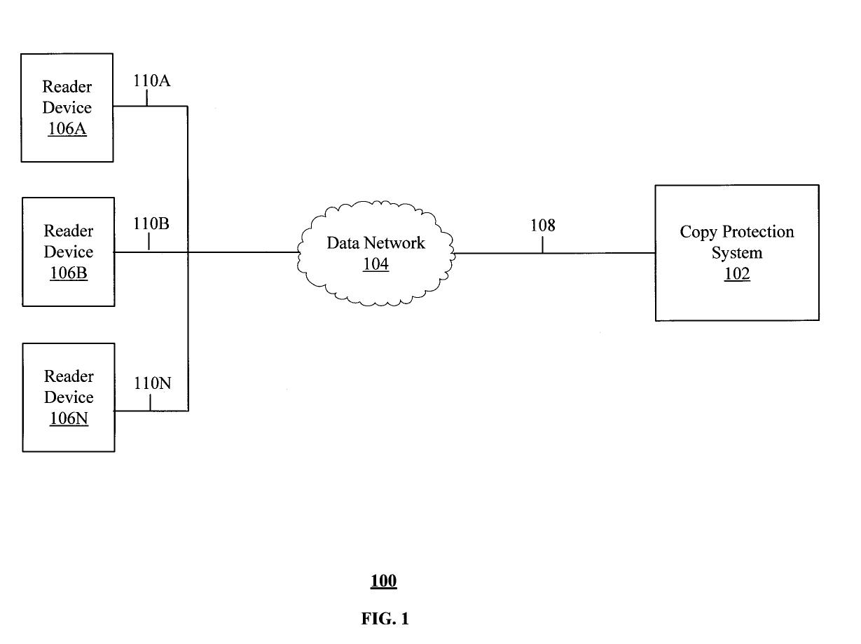

FIG. 1 illustrates a block diagram of an enhanced copy protection system according to an embodiment of the invention. In one embodiment, an enhanced copy protection system 100 may communicatively couple any, or a combination, of a copy protection system 102 and reader devices 106A, 106B, 106N using any, or a combination, of data network 104 and data paths 110A, 110B, 110N, 108. Accordingly, data signals may be transmitted to any of the components of the enhanced copy protection system 100 and transmitted from any of the components of the enhanced copy protection system 100 using any, or a combination, of data network 104 and data paths 110A, 110B, 110N, 108. For example, copy detection event log data, copy risk assessment data signals, or any other data signals may be transmitted to any of the components of the enhanced copy protection system 100 and transmitted from any of the components of the enhanced copy protection system 100 using any, or a combination, of data network 104 and data paths 110A, 110B, 110N, 108.

The data network 104 may be a wireless network, a wired network, or any combination of wireless network and wired network. For example, the data network 104 may include any, or a combination, of a fiber optics network, a passive optical network, a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network configured to transmit or receive a data signal. In addition, the data network 104 may include, without limitation, a telephone line, fiber optics, IEEE Ethernet 802.3, a wide area network (WAN), a LAN, or a global network, such as the Internet. Also, the data network 104 may support, an Internet network, a wireless communication network, a cellular network, or the like, or any combination thereof. The data network 104 may be configured to support broadcast distribution (e.g., in accordance with the Advanced Television Systems Committee-Mobile/Handheld (ATSC M/H) standard) using digital radio devices or digital television devices. The data network 104 may further include one, or any number of the exemplary types of networks mentioned above operating as a stand-alone network or in cooperation with each other. The data network 104 may utilize one or more protocols of one or more network elements to which it is communicatively coupled. The data network 104 may translate to or from other protocols to one or more protocols of network devices. Although the data network 104 is depicted as one network, it should be appreciated that according to one or more embodiments, the data network 104 may comprise a plurality of interconnected networks, such as, for example, a service provider network, the Internet, a broadcaster's network, a cable television network, corporate networks, and home networks. The data network 104 may be configured to perform the functions of the content distribution network described in U.S. patent application Ser. No. 12/248,482 entitled “Systems, Methods And Apparatus For Content Distribution,” filed on Oct. 9, 2008, which is incorporated by reference herein in its entirety.

The copy protection system 102 and reader devices 106A, 106B, 106N may transmit data to and receive data from the data network 104 copy detection event log data, copy risk assessment data, and other data. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. The data network 104 may use standard wireless protocols including IEEE 802.11a, 802.11b and 802.11g. The data network 104 may also use protocols for a wired connection, such as an IEEE Ethernet 802.3.

The reader devices 106A, 106B, 106N may be communicatively coupled to data network 104 via data paths 110A, 110B, 110N, respectively. In one embodiment, the reader devices 106A, 106B, 106N may be configured to display electronic content to an end-user (e.g., subscriber) using a display screen (e.g., a display screen, a plasma screen, a Liquid Crystal Display (LCD) device). The functionalities of the reader devices 106A, 106B, 106N may include those described in U.S. patent application Ser. No. 12/248,331 entitled “Media Display Device And Method Of Operation Thereof,” filed on Oct. 9, 2008, which is incorporated by reference herein in its entirety.

Any electronic device having a display that can render electronic content or images may be used. In one embodiment, reader device 106 may be an electronic reading device. Examples of electronic reading devices include electronic book readers, electronic newspaper readers, electronic paper readers, etc. Examples of an electronic display device are disclosed in U.S. patent application Ser. No. 12/481,677 entitled “Flexible Electronic Device And Method Of Manufacture”; U.S. patent application Ser. No. 12/248,331 entitled “Foldable Media Device”; U.S. patent application Ser. No. 12/332,860 entitled “Touch Sensitive Illuminated Display”; U.S. patent application Ser. No. 12/549,785 entitled “Thin Reader Device”; and U.S. patent application Ser. No. 12/574,721 entitled “Always On Reader Device.” The disclosure of each of these patent applications is incorporated, by reference, it its entirety.

Other examples of electronic reading devices include the Amazon Kindle, the Sony Reader, the Plastic Logic Reader, and the iRex iLiad electronic reader. Other examples of electronic devices include computers (e.g., desktops, notebooks, laptops, tablets, web books, net books), personal digital assistants (PDAs), digital cameras, digital picture frames, music players, potable video players, video game players, telephones, mobile telephones, etc.

Other related disclosures include U.S. Patent Application No. 60/978,748 entitled “Content Distribution And Preloading”; U.S. patent application Ser. No. 12/481,336 entitled “System And Method For Providing Spatial And Temporal Content In An Electronic Device”; U.S. patent application Ser. No. 12/481,705 entitled “System And Method For Providing Sub-Publication Content In An Electronic Device”; U.S. patent application Ser. No. 12/481,306 entitled “Electronic Paper Display Device Event Tracking”; U.S. patent application Ser. No. 12/481,365 entitled “System And Method For Delivering Publication Content To Reader Devices Using Mixed Mode Transmission”; U.S. patent application Ser. No. 12/575,009 entitled “Electronic Advertisement Placement”; and U.S. patent application Ser. No. 12/639,512 entitled “System And Method For Rendering Advertisements On An Electronic Device.” The disclosure of each of these patent applications is incorporated, by reference, in its entirety.

The reader devices 106A, 106B, 106N may include any, or a combination, of software and hardware configured determine (e.g., detect) whether orientation data has been generated that indicates that the display screens of reader devices 106A, 106B, 106N are facing and appropriately aligned with (e.g., parallel to, substantially parallel to) a horizontal surface (e.g., a scanning surface) of a scanning device. That is, the reader devices 106A, 106B, 106N may be configured to determine whether an in-the-clear copying event has occurred. In one embodiment, the reader devices 106, 106B, 106N may be configured to detect whether orientation data has been generated by any, or a combination, of an orientation sensor, a gravity direction detection mechanism, a compass, a photo detector, and an optical sensor. The reader devices 106A, 106B, 106N may process the generated orientation data to determine the orientation of the reader devices 106A, 106B, 106N. If, for example, the orientation data indicates that the orientation of the reader devices 106A, 106B, 106N is such that the display screens of the reader devices 106A, 106B, 106N are facing and aligned with (e.g., parallel to, substantially parallel to) a horizontal surface, the reader devices 106A, 106B, 106N may determine that an in-the-clear copying event has occurred and a copy protection mechanism may be initiated to protect the reader devices 106A, 106B, 106N from further in-the-clear copying.

Given that scanning devices that are not aligned with reader devices 106A, 106B, 106N may be used to perform unauthorized in-the-clear copying, reader devices 106A, 106B, 106N may be configured to determine whether an in-the-clear copying event has occurred based on detecting non-human reading patterns. For example, reader devices 106A, 106B, 106N may use an accelerometer to detect the amount of movement of the reader devices. If, for example, reader devices 106A, 106B, 106N remain in an unmoved state (e.g., a substantially unmoved state) for an amount of time, reader devices 106A, 106B, 106N may determine that an in-the-clear copying event has occurred. In another example, reader devices 106A, 106B, 106N may rely on user prompts (e.g., “Please Confirm That You Are A Human”) to determine whether an in-the-clear copying event has occurred.

The reader devices 106A, 106B, 106N may be configured to transmit copy detection event log data to the copy protection system 102 in response to determining that an in-the-clear copying event has occurred. Copy detection event log data may include any, or a combination, of event time data, event page rate data, event content data, event location data, reader device identification data, and user identification data. In one embodiment, event time data may include data that indicates an approximate time of an in-the-clear copying event. In another embodiment, event page rate data may include data that indicates the rate at which pages of displayed electronic content are turned during an in-the-clear copying event. In another embodiment, event content data may include data that indicates the electronic content that is displayed during an in-the-clear copying event. In another embodiment, event location data may include data that indicates an approximate location of an in-the-clear copying event. In another embodiment, reader device identification data may include data that identifies the reader device at which an in-the-clear copying event has occurred. In another embodiment, user identification data may include data that identifies a user of a reader device at which an in-the-clear copying event has occurred.

The reader devices 106A, 106B, 106N may be coupled to a security chip that is configured to notify (e.g., in real time) a user or the copy protection system 102 that a potential unauthorized in-the-clear copying event has occurred. Such real time notifications may be used to protect highly sensitive documents where knowledge of a potential unauthorized in-the-clear copying event may initiate a change in action (e.g., the use of the sensitive documents). The security chip may be coupled to one or more servers (e.g., authorization servers) configured to determine (e.g., in real time) whether a copying action is authorized and perform one or more encryption or decryption functions based on that determination. The servers may apply one or more business rules to determine whether a copying action is authorized or unauthorized. The security chip of the reader devices 106A, 106B, 106N may be configured to perform one or more functions of the secure IC described in U.S. patent application Ser. No. 12/576,297 entitled “Integrated Electronic Paper Display Controller,” filed on Oct. 9, 2009 and U.S. patent application Ser. No. 12/578,972 entitled “Disabling Electronic Display Devices,” filed on Oct. 14, 2009. The servers described above may be configured to perform one or more functions of the authorization server described in U.S. patent application Ser. No. 12/578,972 entitled “Disabling Electronic Display Devices,” filed on Oct. 14, 2009. The contents of these US patent applications are hereby incorporated by reference in their entirety. Details of the reader devices 106A, 106B, 106N are provided below.

The copy protection system 102 may be communicatively coupled to data network 104 via data path 108. The copy protection system 102 may include, but is not limited to, a computer device or communications device. For example, the copy protection system 102 may include a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to receive copy detection event log data from reader devices 106A, 106B, 106N, process the copy detection event log data by performing risk assessment processing techniques on the copy detection event log data to determine the likelihood that the electronic content displayed on the reader device was subject to unauthorized in-the-clear copying, and transmit copy risk assessment data to the reader devices 106A, 106B, 106N. In one embodiment, copy risk assessment data may include data that indicates the likelihood that the electronic content displayed on the reader device was subject to unauthorized in-the-clear copying. In another embodiment, copy risk assessment data may include data that indicates one or more copy protection mechanisms to be employed by a reader device. It should be noted that reader devices 106A, 106B, 106N may be configured to perform any of the functions performed by the copy protection system 102. Details of the copy protection system 102 are provided below.

The data paths disclosed herein may include any device that communicatively couples devices to each other. For example, a data path may include one or more networks or one or more conductive wires (e.g., copper wires).

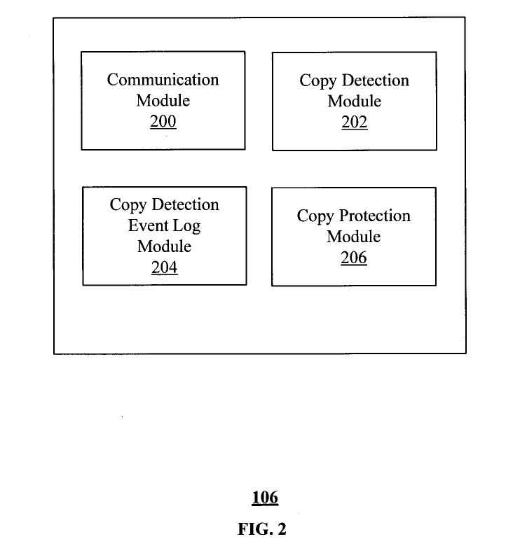

FIG. 2 illustrates exemplary modules of a reader device according to an embodiment of the invention. In an exemplary embodiment, the reader device 106 may include a communication module 200, a copy detection module 202, a copy detection event log module 204, and a copy protection module 206. It is noted that the modules 200, 202, 204, and 206 are exemplary. The functions of the modules 200, 202, 204, and 206 may be performed at other modules remote or local to the reader device 106, and the modules 200, 202, 204, and 206 may be combined or separated.

The communication module 200 may include any, or a combination, of software and hardware configured to transmit copy detection event log data to and receive copy risk assessment data from the copy protection system 102 via data path 110. In one embodiment, the communication module 200 may be configured to communicate the copy risk assessment data received to one or more other modules of the reader device 106, such as: the copy detection module 202, the copy detection event log module 204, and the copy protection module 206. In one embodiment, the communication module 200 may be configured to communicate one or more messages received from one module to one or more other modules.

The copy detection module 202 may include any, or a combination, of software and hardware configured to detect the generation of orientation data. In one embodiment, orientation data may be generated by any, or a combination, of an orientation sensor, a gravity direction detection mechanism, a compass (e.g., a solid state compass), a photo detector, and an optical sensor. An orientation sensor may include any well-known device that is configured to sense the orientation of a display screen of a reader device. For example, the orientation sensor described herein may be configured to perform the orientation sensing techniques described in U.S. Patent Application Publication 2009/0031570 entitled “Portable Electronic Device With Orientation Sensor.” A gravity direction detection mechanism may include any well-known device that is configured to determine the position of a display screen of a reader device relative to the direction of the Earth's gravity at arbitrary times. For example, the gravity direction detection mechanism may be configured to perform the gravity direction detection techniques described in U.S. Pat. No. 7,583,858 entitled “Image Processing Based On Direction Of Gravity.” A compass may include any well-known device that is configured to determine the direction of a display screen of a reader device relative to the earth's magnetic poles. A photo detector may include any well-known device that is configured to detect a scan light source from a scanning device (e.g., a light scan that moves along a display screen of a reader device). An optical sensor may include any well-known device that is configured to sense a scan light source from a scanning device. For example, the optical sensor may be configured to perform the optical sensing techniques described in a publication entitled “In-Cell Type Adaptive Touch For Electrophoretic Display” by Jong-Kwon Lee et al.

In such embodiments, after the orientation data has been generated, the orientation data may be written to (e.g., stored in) a particular memory location (e.g., a register, a portion of random access memory (RAM)). In response to the orientation data being written to the particular memory location, the copy detection module 202 initiate processing the orientation data to determine whether the orientation data indicates that a display screen of a reader device is facing and aligned with (e.g., parallel to, substantially parallel to) a horizontal surface (e.g., a scanning surface) of a scanning device. That is, the copy detection module 202 may be configured to process the generated orientation data to determine whether an in-the-clear copying event has occurred.

The copy detection module 202 may be configured to process the generated orientation data by employing one or more copy detection mechanisms that determine whether an in-the-clear copying event has occurred. In one embodiment, a copy detection mechanism may include using any, or a combination, of orientation sensors, gravity direction detection mechanisms, and compasses (e.g., solid state compasses) coupled to a reader device to detect whether the display screen of the reader device is facing a scanning device. In another embodiment, a copy detection mechanism may include using a configuration of photo detectors or optical sensors coupled to a reader device to detect whether a light (from a scanning device) has scanned the display screen of the reader device. In another embodiment, a copy detection mechanism may include using a combination of page turn detection techniques (e.g., techniques that determine the amount of pages of electronic content turned) and motion sensing devices (e.g., motion sensors, orientation sensors) to detect whether a pre-determined amount of pages have been turned without the position of the reader device being altered. The amount of pages may be determined in accordance with design preferences. For example, the pre-determined amount of pages may be configured to be five (5) pages. In another example, the pre-determined amount of pages may be configured to be ten (10) pages. In another embodiment, a copy detection mechanism may include using event page rate data that indicates the rate at which pages of displayed electronic content are turned to determine whether the rate at which pages are turned is likely to be associated with a machine scanning the pages or a human reading the pages. The threshold rate that is associated with a machine scanning the pages may be determined in accordance with design preferences.

If, for example, the copy detection module 202 determines that an in-the-clear copying event has occurred, the copy detection event log module 204 may generate copy detection event log data that is associated with the in-the-clear copying event. If, however, the copy detection module 202 determines that an in-the-clear copying event has not occurred, the copy detection module 202 may continue to monitor the memory location for new or changed orientation data.

The copy detection event log module 204 may include any, or a combination, of software and hardware configured to generate or store copy detection event log data in response to the occurrence of an in-the-clear copying event. Accordingly, the copy detection event log module 204 may generate or store copy detection event log data that includes any, or a combination, of event time data, event page rate data, event content data, event location data, reader device identification data, and user identification data. The copy detection event log module 204 may be configured to initiate the transmission of the generated copy detection event log data to the copy protection system 102 for risk assessment processing.

The copy protection module 206 may include any, or a combination, of software and hardware configured to employ one or more copy protection mechanisms in response to the occurrence of an in-the-clear copying event. In one embodiment, the copy protection module 206 may be configured to automatically employ one or more copy protection mechanisms once an in-the-clear copying event occurs. In another embodiment, the copy protection module 206 may be configured to employ one or more copy protection mechanisms in accordance with copy risk assessment data received from the copy protection system 102.

In one embodiment, a copy protection mechanism may include displaying watermark data (e.g., displaying “Unauthorized Copying Detected”) with electronic content displayed on the reader device. In another embodiment, a copy protection mechanism may include deleting at least a portion of the electronic content suspected of being copied from the display screen of the reader device or the memory of the reader device. In another embodiment, a copy protection mechanism may include displaying warning data (e.g., displaying “Copying Activity Is Not Authorized”) with the electronic content displayed on the reader device. In another embodiment, a copy protection mechanism may include disabling a reader device or disabling the display of electronic content on a reader device.

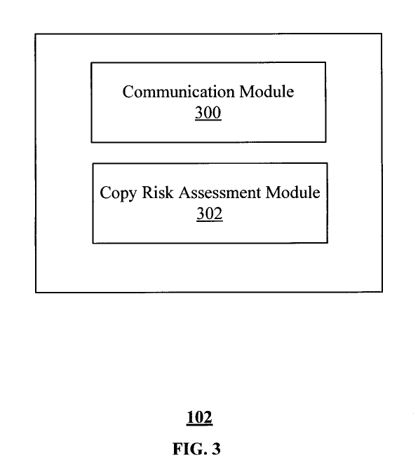

FIG. 3 illustrates exemplary modules of a copy protection system according to an embodiment of the invention. In an exemplary embodiment, the copy protection system 102 may include a communication module 300 and a copy risk assessment module 302. It is noted that the modules 300 and 302 are exemplary. The functions of the modules 300 and 302 may be performed at other modules remote or local to the copy protection system 102, and the modules 300 and 302 may be combined or separated.

The communication module 300 may include any, or a combination, of software and hardware configured to transmit copy risk assessment data to and receive copy detection event log data from the reader device 106 via data path 108. In one embodiment, the communication module 300 may be configured to communicate the copy detection event log data received to one or more other modules of the copy protection system 102, such as the copy risk assessment module 302. In one embodiment, the communication module 300 may be configured to communicate one or more messages received from one module to one or more other modules.

The copy risk assessment module 302 may include any, or a combination, of software and hardware configured to process the received copy detection event log data by performing risk assessment processing techniques on the copy detection event log data to determine the likelihood that electronic content displayed on the reader device was subject to unauthorized in-the-clear copying. In one embodiment, a risk assessment processing technique may include applying a business rule to the copy detection event log data to determine whether the electronic content displayed on the reader device is subject to unauthorized in-the-clear copying. A business rule may indicate an amount of in-the-clear copying that is allowed for a particular end-user (e.g., a subscriber).

For example, a first business rule associated with a first end-user may indicate that the end-user is allowed to copy up to ten pages of electronic content (e.g., proprietary electronic content) per week. In another example, a second business rule associated with a second end-user may indicate that the end-user is allowed to copy up to 50 pages of electronic content per month. In yet another example, a third business rule associated with a third end-user may indicate that the end-user is allowed to copy up to 100 pages of electronic content per month. Accordingly, the copy risk assessment module 302 may consider in-the-clear copying that is in accordance with a business rule as authorized in-the-clear copying.

If, for example, the in-the-clear copying associated with the received copy detection event log data is considered authorized in-the-clear copying, the copy risk assessment module 302 may transmit copy risk assessment data that indicates that the in-the-clear copying is authorized (instructing the reader device to refrain from employing any copy protection mechanisms) to the reader device 106. If, however, the in-the-clear copying associated with the received copy detection event log data is not considered authorized in-the-clear copying, the copy risk assessment module 302 may transmit copy risk assessment data that indicates that the in-the-clear copying is not authorized (instructing the reader device to employ one or more copy protection mechanisms) to the reader device 106. In such embodiments, the copy risk assessment module 302 may transmit the received copy detection event log data to one or more systems configured to aid an individual in taking legal action against the end-user of the reader device 106.

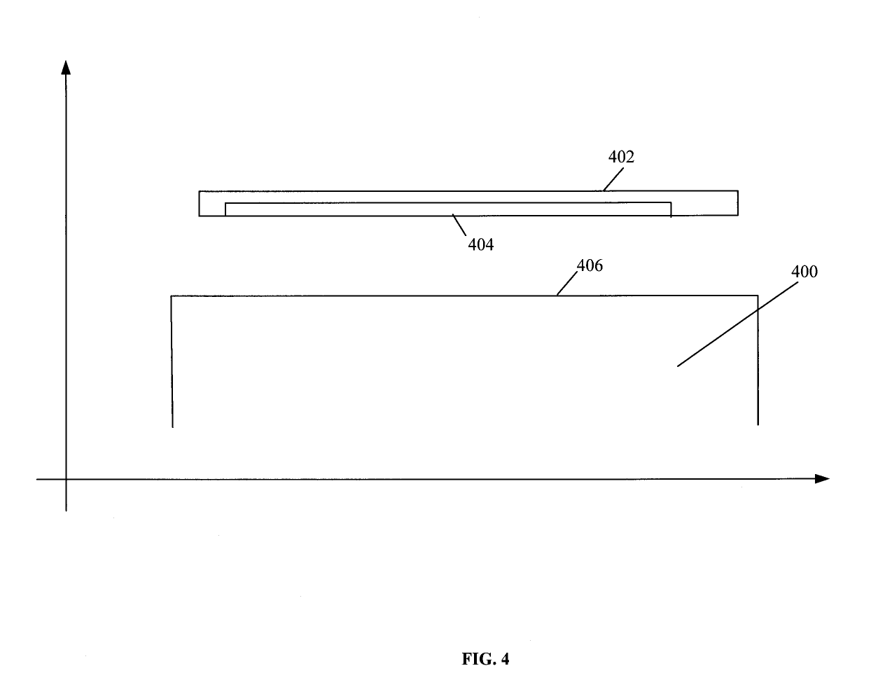

FIG. 4 illustrates a schematic diagram of a reader device in a copy detection configuration according to an embodiment of the invention. As illustrated, an in-the-clear copying event may occur when a display screen 404 of a reader device 402 is facing and aligned with (e.g., parallel to, substantially parallel to) a horizontal surface 406 (e.g., a scanning surface) of a scanning device 400. In one embodiment, a reader device may employ one or more copy protection mechanisms once an in-the-clear copying event has occurred. In another embodiment, a reader device may transmit copy detection event log data to the copy protection system 102 for further risk assessment processing once an in-the-clear copying event has occurred.

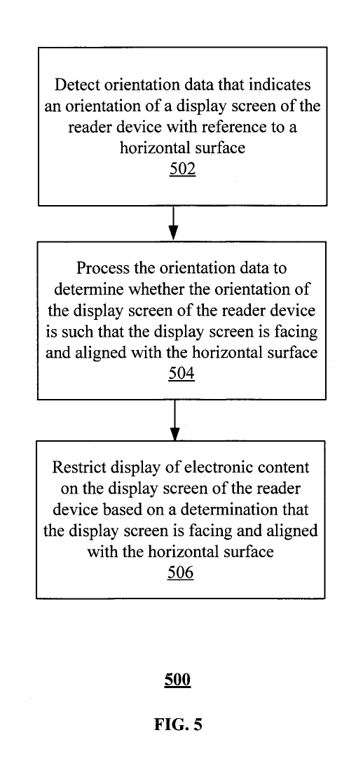

FIG. 5 is a flow chart illustrating a method of providing enhanced copy protection on a reader device according to an embodiment of the invention. This exemplary method is provided by way of example, as there are a variety of ways to carry out methods disclosed herein. The method 500 shown in FIG. 5 can be executed or otherwise performed by one or a combination of various systems. The method 500 is described below as carried out by the reader device 106 shown in FIG. 1 by way of example, and various elements of the reader device 106 are referenced in explaining the example method of FIG. 5. Each block shown in FIG. 5 represents one or more processes, methods, or subroutines carried in the exemplary method 500. Referring to FIG. 5, the exemplary method 500 may begin at block 502.

In block 502, the method 500 may include detecting orientation data that indicates an orientation of a display screen of the reader device with reference to a horizontal surface. In one embodiment, the copy detection module 202 of the reader device 106 may detect orientation data that indicates an orientation of a display screen of the reader device with reference to a horizontal surface by scanning a particular memory location (e.g., a register, a portion of a RAM). For example, the copy detection module 202 may scan the memory location of new orientation data or changed orientation data. The method 500 may continue to block 504.

In block 504, the method 500 may include processing the orientation data to determine whether the orientation of the display screen of the reader device is such that the display screen is facing and aligned with the horizontal surface. In one embodiment, the copy detection module 202 of the reader device 106 may process the orientation data to determine whether the orientation of the display screen of the reader device is such that the display screen is facing and aligned with (e.g., parallel to, substantially parallel to) the horizontal surface (e.g., a scanning surface of a scanning device). The method 500 may continue to block 506.

In block 506, the method 500 may include restricting display of electronic content on the display screen of the reader device based on a determination that the display screen is facing and aligned with the horizontal surface. In one embodiment, the copy protection module 206 of the reader device 106 may restrict display of electronic content on the display screen of the reader device based on a determination that the display screen is facing and aligned with (e.g., parallel to, substantially parallel to) the horizontal surface. The method 500 may then end.

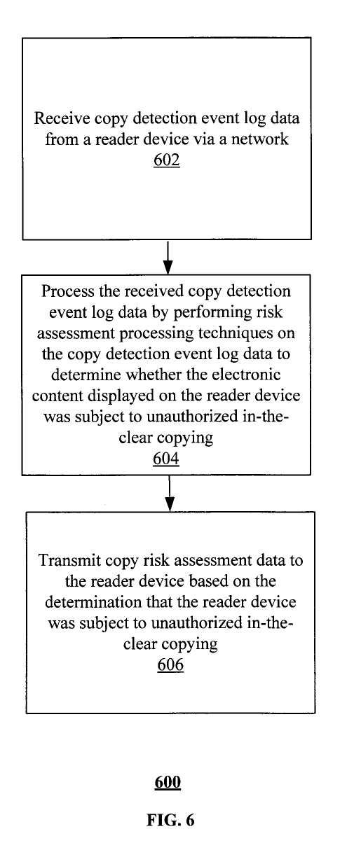

FIG. 6 is a flow chart illustrating another method of providing enhanced copy protection on a reader device according to an embodiment of the invention. This exemplary method is provided by way of example, as there are a variety of ways to carry out methods disclosed herein. The method 600 shown in FIG. 6 can be executed or otherwise performed by one or a combination of various systems. The method 600 is described below as carried out by the copy protection system 102 shown in FIG. 1 by way of example, and various elements of the copy protection system 102 are referenced in explaining the example method of FIG. 6. Each block shown in FIG. 6 represents one or more processes, methods, or subroutines carried in the exemplary method 600. Referring to FIG. 6, the exemplary method 600 may begin at block 602.

In block 602, the method 600 may include receiving copy detection event log data from a reader device via a network. In one embodiment, the communication module 300 of the copy protection system 102 may receive copy detection event log data from a reader device via a network. The method 600 may continue to block 604.

In block 604, the method 600 may include processing the received copy detection event log data by performing risk assessment processing techniques on the copy detection event log data to determine whether the electronic content displayed on the reader device was subject to unauthorized in-the-clear copying. In one embodiment, the copy risk assessment module 302 of the copy protection system 102 may process the received copy detection event log data by performing risk assessment processing techniques on the copy detection event log data to determine whether the electronic content displayed on the reader device was subject to unauthorized in-the-clear copying. The method 600 may continue to block 606.

In block 606, the method 600 may include transmitting copy risk assessment data to the reader device based on the determination that the reader device was subject to unauthorized in-the-clear copying. In one embodiment, the copy risk assessment module 302 of the copy protection system 102 may transmit copy risk assessment data to the reader device based on the determination that the reader device was subject to unauthorized in-the-clear copying. The method 600 may then end.

The description above describes systems, networks, and reader devices, that may include one or more modules, some of which are explicitly shown in the figures. As used herein, the term “module” may be understood to refer to any, or a combination, of computer executable software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein is tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

1. A computer-implemented method of providing enhanced copy protection on a reader device, the computer-implemented method comprising:
detecting orientation data that indicates an orientation of a display screen of the reader device with reference to a horizontal surface;
processing the orientation data to determine whether the orientation of the display screen of the reader device is such that the display screen is facing and aligned with the horizontal surface; and
restricting display of electronic content on the display screen of the reader device based on a determination that the display screen is facing and aligned with the horizontal surface.

2. The computer-implemented method of claim 1, wherein the orientation data is generated by one or more orientation sensors.

3. The computer-implemented method of claim 1, wherein the orientation data is generated by one or more gravity direction detection mechanisms.

4. The computer-implemented method of claim 1, wherein the orientation data is generated by one or more solid state compasses.

5. The computer-implemented method of claim 1, wherein the orientation data is generated by one or more photo detectors.

6. The computer-implemented method of claim 1, wherein the horizontal surface comprises a scanning surface of a scanning device.

7. The computer-implemented method of claim 1, further comprising storing copy detection event log data.

8. The computer-implemented method of claim 7, wherein the copy detection event log data comprises at least one of event time data, event page rate data, event content data, event location data, reader device identification data, and user identification data.

9. The computer-implemented method of claim 7, further comprising transmitting the copy detection event log data to a copy protection system for risk assessment processing.

10. The computer-implemented method of claim 1, wherein restricting display of electronic content further comprises deleting at least a portion of the displayed electronic content.

11. The computer-implemented method of claim 1, wherein restricting display of electronic content further comprises displaying watermark data on the display screen of the reader device.

12. The computer-implemented method of claim 1, wherein restricting display of electronic content further comprises displaying warning data on the display screen of the reader device.

13. The computer-implemented method of claim 1, wherein the reader device comprises an electrophoretic display (EPD) device.

14. The computer-implemented method of claim 1, wherein the network comprises a content distribution network (CDN).

15. A computer-implemented system for providing enhanced copy protection on a reader device, the computer-implemented system comprising:
a copy detection computing apparatus configured to detect orientation data that indicates an orientation of a display screen of the reader device with reference to a horizontal surface and process the orientation data to determine whether the orientation of the display screen of the reader device is such that the display screen is facing and aligned with the horizontal surface; and
a copy protection computing apparatus configured to restrict display of electronic content on the display screen of the reader device based on a determination that the display screen is facing and aligned with the horizontal surface.

16. The computer-implemented system of claim 15, wherein the orientation data is generated by one or more orientation sensors.

17. The computer-implemented system of claim 15, wherein the orientation data is generated by one or more gravity direction detection mechanisms.

18. The computer-implemented system of claim 15, wherein the orientation data is generated by one or more solid state compasses.

19. The computer-implemented system of claim 15, wherein the orientation data is generated by one or more photo detectors.

20. The computer-implemented system of claim 15, wherein the horizontal surface comprises a scanning surface of a scanning device.

21. The computer-implemented system of claim 15, further comprising a copy detection event log computing apparatus configured to store copy detection event log data.

22. The computer-implemented system of claim 21, wherein the copy detection event log data comprises at least one of event time data, event page rate data, event content data, event location data, reader device identification data, and user identification data.

23. The computer-implemented system of claim 21, wherein the copy detection event log computing apparatus is further configured to transmit the copy detection event log data to a copy protection system for risk assessment processing.

24. The computer-implemented system of claim 15, wherein the copy protection computing apparatus is further configured to restrict display of electronic content by deleting at least a portion of the displayed electronic content.

25. The computer-implemented system of claim 15, wherein the copy protection computing apparatus is further configured to restrict display of electronic content by displaying watermark data on the display screen of the reader device.

26. The computer-implemented system of claim 15, wherein the copy protection computing apparatus is further configured to restrict display of electronic content by displaying warning data on the display screen of the reader device.

27. The computer-implemented system of claim 15, wherein the reader device comprises an electrophoretic display (EPD) device.

28. The computer-implemented system of claim 15, wherein the network comprises a content distribution network (CDN).
